(19) United States
(12) Patent Application Publication
(10) Pub. No.: US 2024/0049096 A1
(43) Pub. Date: Feb. 8, 2024

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Jiren HAN, Shenzhen (CN); Yin GAO, Shenzhen (CN)

(73) Assignee: ZTE CORPORATION, Shenzhen (CN)

(21) Appl. No.: 18/489,976

(22) Filed: Oct. 19, 2023

Related U.S. Application Data
(63) Continuation of application No. PCT/CN21/89316, filed on Apr. 23, 2021.

(51) Int. Cl. H04W 36/32

(52) U.S. Cl. CPC H04W 36/32

(57) ABSTRACT

Method, device and computer program product for wireless communication are provided. A method includes: transmitting, by a first wireless communication node, unmanned aerial vehicle, UAV, related information of a UAV to a second wireless communication node, wherein the UAV related information comprises at least one of UAV Flight Path Information or UAV Height Information.

This application is a continuation of PCT/CN2021/089316, filed Apr. 23, 2021, the content of which is incorporated herein by reference in its entirety.

### TECHNICAL FIELD

This document is directed generally to wireless communications.

### BACKGROUND

An Unmanned Aerial System (UAS) is the combination of an Unmanned Aerial Vehicle (UAV), sometimes called a drone, and a UAV controller (UAVC). A UAV is generally an aircraft without a human pilot on board (but there may still be a human pilot on board in some cases). The UAV can be controlled from an operator via a UAV controller and has a range of autonomous flight capabilities.

UAVs range in size and weight from small, light aircraft often used for recreational purposes to large, heavy aircraft which are often more suited to commercial applications. Regulatory requirements vary across this range and vary on a regional basis.

### SUMMARY

The present disclosure relates to methods, devices, and computer program products for wireless communication, which can allow UAV related information be transmitted between wireless communication nodes.

One aspect of the present disclosure relates to a wireless communication method. In an embodiment, the wireless communication method includes: transmitting, by a first wireless communication node, unmanned aerial vehicle, UAV, related information of a UAV to a second wireless communication node, wherein the UAV related information comprises at least one of UAV Flight Path Information or UAV Height Information.

Another aspect of the present disclosure relates to a wireless communication method. In an embodiment, the wireless communication method includes: receiving, by a second wireless communication node, unmanned aerial vehicle, UAV, related information of a UAV from a first wireless communication node, wherein the UAV related information comprises at least one of UAV Flight Path Information or UAV Height Information; and transmitting, by the second wireless communication node, a response message in response to the UAV related information to the first wireless communication node.

Another aspect of the present disclosure relates to a wireless communication node. In an embodiment, the wireless communication node includes a communication unit and a processor. The processor is configured to transmit unmanned aerial vehicle, UAV, related information of a UAV to a second wireless communication node, wherein the UAV related information comprises at least one of UAV Flight Path Information or UAV Height Information.

Another aspect of the present disclosure relates to a wireless communication node. In an embodiment, the wireless communication node includes a communication unit and a processor. The processor is configured to: receive unmanned aerial vehicle, UAV, related information of a UAV from a first wireless communication node, wherein the UAV related information comprises at least one of UAV Flight Path Information or UAV Height Information; and transmit a response message in response to the UAV related information to the first wireless communication node.

Various embodiments may preferably implement the following features:

Preferably or in some embodiments, the UAV Flight Path Information comprises at least one of way point location or time stamp information.

Preferably or in some embodiments, the way point location comprises location coordinates of the UAV.

Preferably or in some embodiments, the time stamp information comprises absolute time points.

Preferably or in some embodiments, the UAV Height Information comprises information about a height of the UAV above a sea level.

Preferably or in some embodiments, the first wireless communication node and the second wireless communication node are gNodeBs, and the UAV related information is transmitted to the second wireless communication node via an Xn interface.

Preferably or in some embodiments, the UAV related information is transmitted to the second wireless communication node via a Next Generation Radio Access Network, NG-RAN, Configuration Update message, a Handover Request message, or a Retrieve user equipment, UE, Context Request message.

Preferably or in some embodiments, the first wireless communication node is configured to receive a response message from to the second wireless communication node via a NG-RAN Configuration Acknowledge message, a Handover Request Acknowledge message, or a Retrieve UE Context Response message.

Preferably or in some embodiments, the first wireless communication node is a gNodeB central unit, gNB-CU, and the second wireless communication node is a gNodeB distributed unit, gNB-DU, and the UAV related information is transmitted to the second wireless communication node via an F1 interface.

Preferably or in some embodiments, the UAV related information is transmitted to the second wireless communication node via a gNB-CU Configuration Update message, a UE Context Setup Request message, or a UE Context Modification Request message.

Preferably or in some embodiments, the first wireless communication node is configured to receive a response message from to the second wireless communication node via a gNB-CU Configuration Update Acknowledge message, or a UE Context Setup Response message, or a UE Context Modification Response message.

Preferably or in some embodiments, the first wireless communication node and the second wireless communication node are gNodeBs, and the UAV related information is received via an Xn interface.

Preferably or in some embodiments, the UAV related information is received via a Next Generation Radio Access Network, NG-RAN, Configuration Update message, or a Handover Request message, or a Retrieve user equipment, UE, Context Request message.

Preferably or in some embodiments, the response message is transmitted via a NG-RAN Configuration Acknowledge message, or a Handover Request Acknowledge message, or a Retrieve UE Context Response message.

Preferably or in some embodiments, the first wireless communication node is a gNodeB central unit, gNB-CU, and the second wireless communication node is a gNodeB distributed unit, gNB-DU, and the UAV related information is received via an F1 interface.

Preferably or in some embodiments, the UAV related information is received via a gNB-CU Configuration Update message, or a UE Context Setup Request message, or a UE Context Modification Request message.

The present disclosure relates to a computer program product including a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF DRAWINGS

FIG. 1 shows a schematic diagram of exchange of UAV related information between two NG-RAN nodes according to an embodiment of the present disclosure.

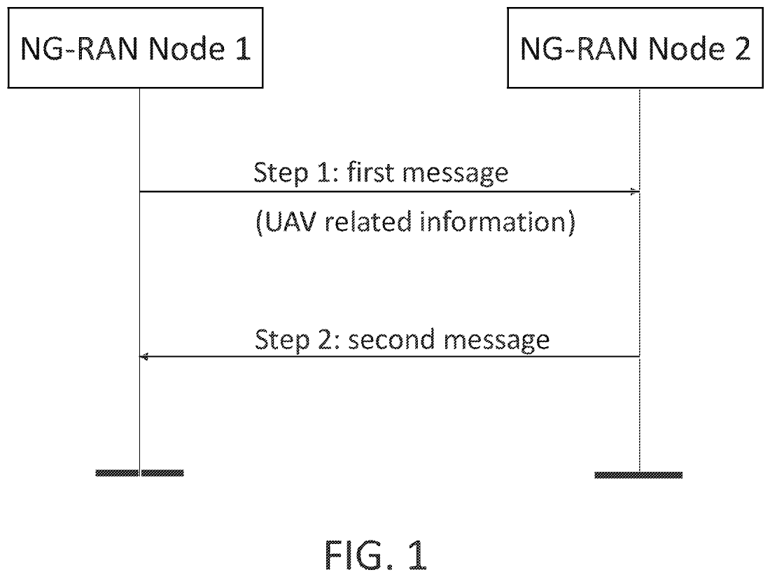

FIG. 2 shows a schematic diagram of transmission of UAV related information from gNB-CU to gNB-DU according to an embodiment of the present disclosure.

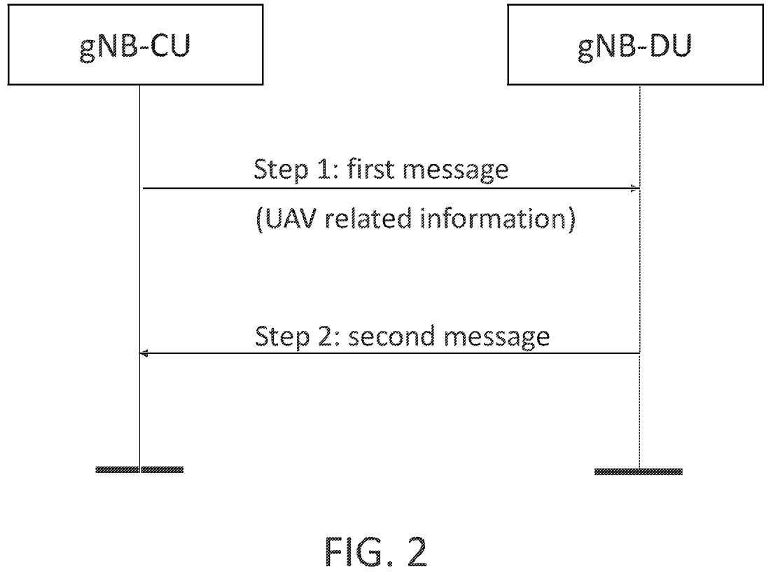

FIG. 3 shows an example of a schematic diagram of a wireless communication node according to an embodiment of the present disclosure.

FIG. 4 shows an example of a schematic diagram of another wireless communication node according to another embodiment of the present disclosure.

FIG. 5 shows a flowchart of a wireless communication method according to an embodiment of the present disclosure.

FIG. 6 shows a flowchart of another wireless communication method according to an embodiment of the present disclosure.

### DETAILED DESCRIPTION

In new radio (NR), new architecture and new features of the base station are introduced. The NR base station can be also called gNB. The interface between the gNB and UAV is called Uu, while the interface between different gNBs is called Xn. In addition, the gNB can be split into two parts, i.e., the CU (Central Unit) and DU (Distributed Unit), and the interface between the gNB-CU and gNB-DU is called F1. In some embodiments, in an NR base station, there is only one gNB-CU, and one gNB-CU is able to control multiple gNB-DUs. The gNB can get the UAV information from the UAV via Uu.

In some approaches, the function of UAV has been introduced in NR. However, the detailed UAV related parameters and UAV information reporting procedures over different interfaces in the radio-access network (RAN) side are unclear.

In some aspects of the present disclosure, UAV related information and UAV information reporting/transmitting procedures are provided.

In some embodiments of the present disclosure, the UAV related information can comprise at least one of: Flight Path Information of a UAV or UAV Height Information of the UAV.

In some embodiments, the Flight Path Information can comprise at least one of the parameters: way point location or time stamp information. In some embodiments, the way point location is the form of the location coordinates. In some embodiments, the way point location includes location coordinates of the UAV. In some embodiments, the time stamp information includes absolute time information. For example, absolute time information can be in a format YY-MM-DD HH:MM:SS, in which YY indicates year, the former MM indicates month, DD indicates date, HH indicates hour, the latter MM indicates minute, and SS indicates second.

In some embodiments, the UAV height information includes information about the height of the UAV above the sea level.

In some embodiments, the RAN side (e.g., a gNB) can receive the UAV related information from the UAV, and the UAV related information can be exchanged over different RAN interfaces, including Xn and F1.

With the UAV related information, the gNB can evaluate the planned flight path of UAV and adjust the schedule of handover, including the cell handover, beam switching and multiple Transmission/Reception Points (TRP) switching.

In the description herein after, the sending node is referred to as the first node, the receiving node is referred to as the second node, the message transmitted from the first node to the second node is referred to as the first message, and the response message from the second node to the first node is referred to as the second message.

In some embodiments, the first message includes the UAV related information. The first node can comprise one of: gNB and gNB-CU, while the second node can comprise one of: gNB and gNB-DU.

### Embodiment 1: Exchange of UAV Related Information Between Two NG-RAN Nodes

In this embodiment, both of the nodes are NG-RAN nodes, and the first message is Xn interface signaling. The first message can be but not limited to an NG-RAN Configuration Update message, a Handover Request message, or a Retrieve UE Context Request message. The second message can be but not limited to an NG-RAN Configuration Acknowledge message, a Handover Request Acknowledge message, or a Retrieve UE Context Response message.

In step 1, the NG-RAN node 1 (i.e., the first node) sends the first message to the NG-RAN node 2 (i.e., the first node), which includes UAV related information. In this embodiment, the UAV related information is at least one of the UAV Flight Path Information or the UAV Height Information. In detail, the UAV Flight Path Information can comprise at least one of the parameters: way point location or time stamp information. To be more specific, the way point location is the form of the location coordinates, and the time stamp information is the absolute time information (in a format YY-MM-DD HH:MM:SS). The UAV height Information is information about the height of UAV above the sea level.

In step 2, the NG-RAN node 2 sends the second message to the NG-RAN node 1.

With such a procedure, the NG-RAN node 2 can obtain the UAV Flight Path Information from the NG-RAN node 1 and adjust the timing of the handover, including the cell handover, beam switching and multiple TRPs switching. In addition, the NG-RAN node 2 is able to optimize the measurement configuration to the UAV based on the UAV related information.

### Embodiment 2: Exchange of UAV Flight Path Information Between gNB-CU and gNB-DU

In this embodiment, the first node is gNB-CU, the second node is gNB-DU and the first/second message is F1 interface signaling. In this embodiment, the first message can be but not limited to a gNB-CU Configuration Update message, a UE Context Setup Request message, or a UE Context Modification Request message. The second message can be but not limited to a gNB-CU Configuration Update Acknowledge message, a UE Context Setup Response message, or a UE Context Modification Response message.

Step 1: The gNB-CU sends the first message to the gNB-DU, which includes UAV related information, i.e. the UAV Fight Path information and UAV Height information. In this embodiment, the UAV Flight Path Information can comprise at least one of the parameters: way point location and time stamp information. To be more specific, the way point location is the form of the location coordinates, and the time stamp information is the absolute time information (in a format YY-MM-DD HH:MM:SS). The UAV height Information is information about the height of UAV above the sea level.

Step 2: The gNB-DU sends the second message to the gNB-CU.

With such a procedure, the gNB-DU can obtain the UAV Flight Path information from the gNB-CU and adjust the timing of the handover, including the cell handover, beam switching and multiple TRPs switching.

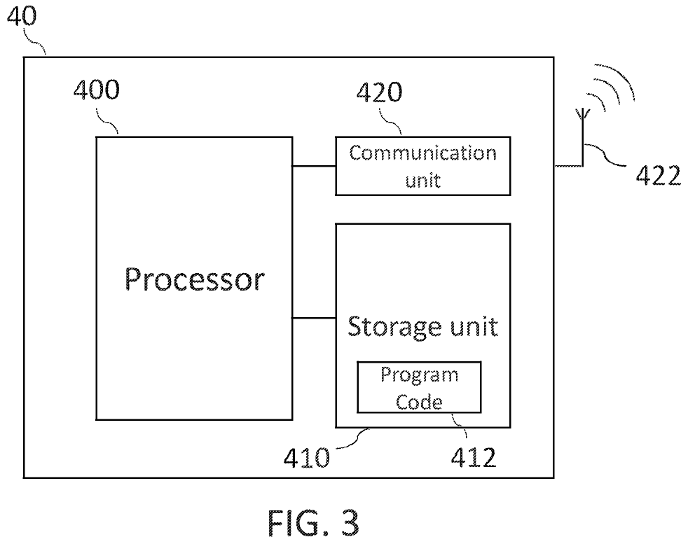

FIG. 3 relates to a schematic diagram of a wireless communication node 40 (e.g., a network device) according to an embodiment of the present disclosure. The wireless communication node 40 may be a satellite, a base station (BS) (e.g., a gNB), a unit of a BS (e.g., a gNB-CU), a network entity, a Mobility Management Entity (MME), Serving Gateway (S-GW), Packet Data Network (PDN) Gateway (P-GW), a radio access network (RAN), a next generation RAN (NG-RAN), a data network, a core network or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), etc. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422.

In an embodiment, the storage unit 410 and the program code 412 may be omitted. The processor 400 may include a storage unit with stored program code.

The processor 400 may implement any steps described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from another wireless communication node or a UAV.

In some embodiments, the wireless communication node 40 may be used to perform the operations of the first node described above. In some embodiments, the processor 400 and the communication unit 420 collaboratively perform the operations described above. For example, the processor 400 performs operations and transmit or receive signals through the communication unit 420.

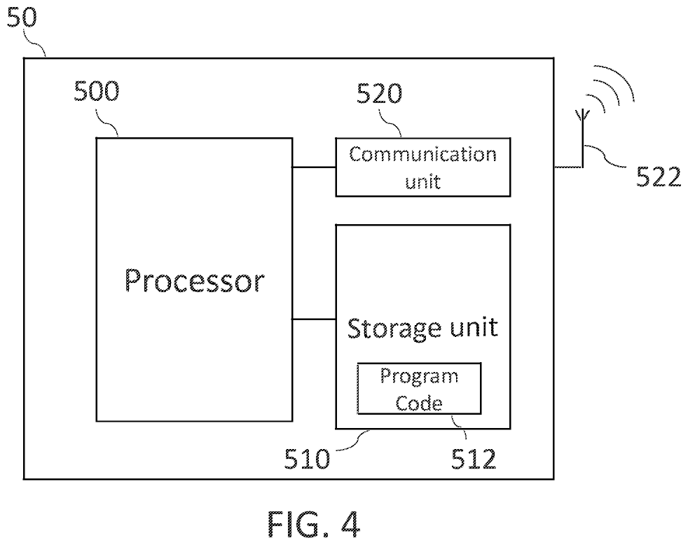

FIG. 4 relates to a schematic diagram of a wireless communication node 50 (e.g., a network device) according to an embodiment of the present disclosure. The wireless communication node 50 may be a satellite, a base station (BS) (e.g., a gNB), a unit of a BS (e.g., a gNB-DU), a network entity, a Mobility Management Entity (MME), Serving Gateway (S-GW), Packet Data Network (PDN) Gateway (P-GW), a radio access network (RAN), a next generation RAN (NG-RAN), a data network, a core network or a Radio Network Controller (RNC), and is not limited herein. In addition, the wireless communication node 50 may include (perform) at least one network function such as an access and mobility management function (AMF), a session management function (SMF), a user place function (UPF), a policy control function (PCF), an application function (AF), etc. The wireless communication node 50 may include a processor 500 such as a microprocessor or ASIC, a storage unit 510 and a communication unit 520. The storage unit 510 may be any data storage device that stores a program code 512, which is accessed and executed by the processor 500. Examples of the storage unit 512 include but are not limited to a SIM, ROM, flash memory, RAM, hard-disk, and optical data storage device. The communication unit 520 may be a transceiver and is used to transmit and receive signals (e.g., messages or packets) according to processing results of the processor 500. In an example, the communication unit 520 transmits and receives the signals via at least one antenna 522.

In an embodiment, the storage unit 510 and the program code 512 may be omitted. The processor 500 may include a storage unit with stored program code.

The processor 500 may implement any steps described in exemplified embodiments on the wireless communication node 50, e.g., via executing the program code 512.

The communication unit 520 may be a transceiver. The communication unit 520 may as an alternative or in addition be combining a transmitting unit and a receiving unit configured to transmit and to receive, respectively, signals, messages, or information to and from another wireless communication node or a UAV.

In some embodiments, the wireless communication node 50 may be used to perform the operations of the second node described above. In some embodiments, the processor 500 and the communication unit 520 collaboratively perform the operations described above. For example, the processor 500 performs operations and transmit or receive signals through the communication unit 520.

A wireless communication method is also provided according to an embodiment of the present disclosure. In an embodiment, the wireless communication method may be performed by using a wireless communication node (e.g., a gNB or a gNB-CU). In an embodiment, the wireless communication terminal may be implemented by using the wireless communication node 40 described above, but is not limited thereto.

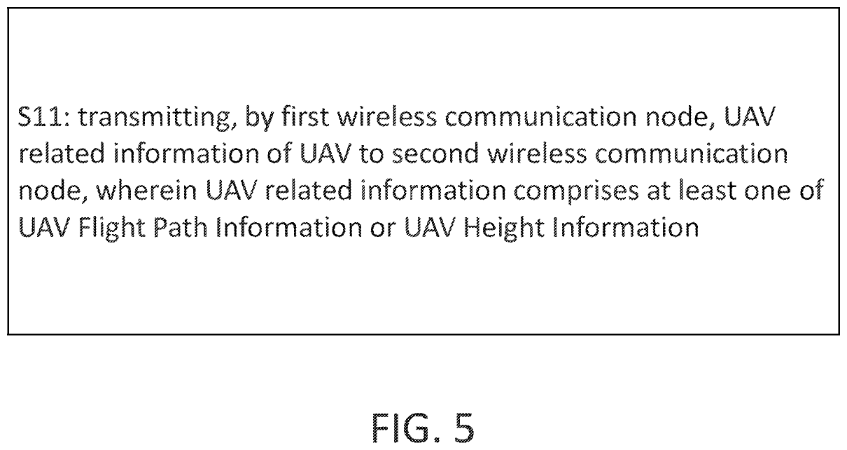

Referring to FIG. 5, in an embodiment, the wireless communication method includes: transmitting, by a first wireless communication node, unmanned aerial vehicle, UAV, related information of a UAV to a second wireless communication node, wherein the UAV related information comprises at least one of UAV Flight Path Information or UAV Height Information (S11).

Details in this regard can be ascertained with reference to the paragraphs above, and will not be repeated herein.

Another wireless communication method is also provided according to an embodiment of the present disclosure. In an embodiment, the wireless communication method may be performed by using a wireless communication node (e.g., a gNB or a gNB-DU). In an embodiment, the wireless communication terminal may be implemented by using the wireless communication node 50 described above, but is not limited thereto.

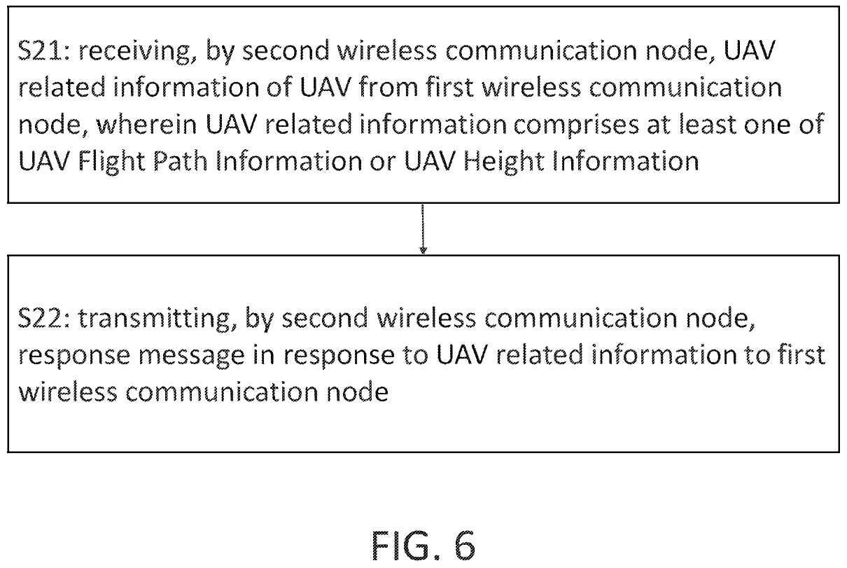

Referring to FIG. 6, in an embodiment, the wireless communication method includes: receiving, by a second wireless communication node, unmanned aerial vehicle, UAV, related information of a UAV from a first wireless communication node, wherein the UAV related information comprises at least one of UAV Flight Path Information or UAV Height Information (S21); and transmitting, by the second wireless communication node, a response message in response to the UAV related information to the first wireless communication node (S22).

In an embodiment, the response message can be the second message described above.

Details in this regard can be ascertained with reference to the paragraphs above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method comprising:
transmitting, by a first wireless communication node, unmanned aerial vehicle (UAV) related information of a UAV to a second wireless communication node,
wherein the UAV related information comprises at least one of UAV Flight Path Information or UAV Height Information.

2. The wireless communication method of claim 1, wherein the UAV Flight Path Information comprises at least one of way point location or time stamp information.

3. The wireless communication method of claim 2, wherein the way point location comprises location coordinates of the UAV.

4. The wireless communication method of claim 2, wherein the time stamp information comprises absolute time points.

5. The wireless communication method of claim 1, wherein the UAV Height Information comprises information about a height of the UAV above a sea level.

6. The wireless communication method of claim 1, wherein the first wireless communication node and the second wireless communication node are gNodeBs, and the UAV related information is transmitted to the second wireless communication node via an Xn interface.

7. The wireless communication method of claim 6, wherein the UAV related information is transmitted to the second wireless communication node via a NG-RAN Configuration Update message, or a Handover Request message, or a Retrieve UE Context Request message.

8. The wireless communication method of claim 6, wherein the first wireless communication node is configured to receive a response message from to the second wireless communication node via a NG-RAN Configuration Acknowledge message, or a Handover Request Acknowledge message, or a Retrieve UE Context Response message.

9. The wireless communication method of claim 1, wherein the first wireless communication node is a gNodeB central unit, gNB-CU, and the second wireless communication node is a gNodeB distributed unit, gNB-DU, and the UAV related information is transmitted to the second wireless communication node via an F1 interface.

10. The wireless communication method of claim 9, wherein the UAV related information is transmitted to the second wireless communication node via a gNB-CU Configuration Update message, or a UE Context Setup Request message, or a UE Context Modification Request message;
wherein the first wireless communication node is configured to receive a response message from to the second wireless communication node via a gNB-CU Configuration Update Acknowledge message, or a UE Context Setup Response message, or a UE Context Modification Response message.

11. A wireless communication method comprising:
receiving, by a second wireless communication node, unmanned aerial vehicle (UAV) related information of a UAV from a first wireless communication node, wherein the UAV related information comprises at least one of UAV Flight Path Information or UAV Height Information; and
transmitting, by the second wireless communication node, a response message in response to the UAV related information to the first wireless communication node.

12. The wireless communication method of claim 11, wherein the UAV Flight Path Information comprises at least one of way point location or time stamp information.

13. The wireless communication method of claim 12, wherein the way point location comprises location coordinates of the UAV.

14. The wireless communication method of claim 12, wherein the time stamp information comprises absolute time points.

15. The wireless communication method of claim 11, wherein the UAV Height Information comprises information about a height of the UAV above a sea level.

16. The wireless communication method of claim 11, wherein the first wireless communication node and the second wireless communication node are gNodeBs, and the UAV related information is received via an Xn interface.

17. The wireless communication method of claim 16, wherein the UAV related information is received via a NG-RAN Configuration Update message, or a Handover Request message, or a Retrieve UE Context Request message.

18. The wireless communication method of claim 16, wherein the response message is transmitted via a NG-RAN Configuration Acknowledge message, or a Handover Request Acknowledge message, or a Retrieve UE Context Response message.

19. The wireless communication method of claim 11, wherein the first wireless communication node is a gNodeB central unit, gNB-CU, and the second wireless communication node is a gNodeB distributed unit, gNB-DU, and the UAV related information is received via an F1 interface;
wherein the UAV related information is received via a gNB-CU Configuration Update message, or a UE Context Setup Request message, or a UE Context Modification Request message;
wherein the response message is transmitted via a gNB-CU Configuration Update Acknowledge message, or a UE Context Setup Response message, or a UE Context Modification Response message.

20. A wireless communication node, comprising:
a communication unit; and
a processor configured to:
transmit unmanned aerial vehicle (UAV) related information of a UAV to a second wireless communication node, wherein the UAV related information comprises at least one of UAV Flight Path Information or UAV Height Information.
